(19) United States
(12) Patent Application Publication
(10) Pub. No.: US 2017/0103349 A1
(43) Pub. Date: Apr. 13, 2017

(54) Systems & Methods for Generating Hotel Reservations

(71) Applicant: Ercan Ersergin, Roswell, GA (US)

(72) Inventor: Ercan Ersergin, Roswell, GA (US)

(21) Appl. No.: 15/372,143

(22) Filed: Dec. 7, 2016

Related U.S. Application Data
(62) Division of application No. 14/882,177, filed on Oct. 13, 2015.

(51) Int. Cl. G06Q 10/02; G06Q 30/08; G06Q 50/12

(52) U.S. Cl. CPC G06Q 10/02; G06Q 50/12; G06Q 30/08

(57) ABSTRACT

Certain embodiments relate to generating hotel reservations that includes: generating a hotel bid based on hotel criteria; identifying hotels matching some of the hotel criteria; determining the hotel bid price associated with the hotels is greater than the asking price; identifying a subset of hotels that receive hotel bids where the hotel bid price is above the asking price; transmitting the hotel bid directly to the hotels in the subset; receiving one or more counteroffers with a new asking price from one or more hotels in the subset; identifying a target hotel system associated with the hotel having the lowest new asking price; generating a counteroffer hotel bid with the lowest new asking price; transmitting the counteroffer hotel bid to a client device associated with a user; receiving an acceptance of the counteroffer hotel bid; and generating a hotel reservation based on the counteroffer hotel bid.

### CROSS-REFERENCE TO RELATED APPLICATIONS

This application is a divisional of U.S. patent application Ser. No. 14/882,177, filed Oct. 13, 2015.

### FIELD OF THE DISCLOSURE

Embodiments of the disclosure relate to systems and methods for generating hotel reservations.

### STATEMENT REGARDING FEDERALLY SPONSORED RESEARCH

None

### BACKGROUND

Many online travel companies, such as Expedia® and Priceline®, have websites that act as an intermediary service between hotels and customers. Typically, these websites display information about various hotels and a customer can submit a bid to book a hotel room. However, the process of bidding on a hotel room through online travel companies has several disadvantages. That is, the bidding process appears to be conducted similarly to an auction, but is not an auction at all. Rather, it operates as a venue for customers to bid on hotel rooms at pre-negotiated contract rates previously established between an online travel company and hotels. Furthermore, online travel companies do not directly communicate bids they receive from customers to hotels. As a result, customers cannot negotiate room rates with any of the hotels, which results in lower occupancy rates for hotels as some customers do not wish to passively accept the pre-negotiated room prices. Accordingly, there is a need for a hotel reservation system that facilitates competition-style bargaining between customers and hotels, thereby increasing occupancy rates for hotels. The present disclosure addresses this need.

### SUMMARY

Some or all of the above needs and/or problems may be addressed by certain embodiments of the disclosure. Certain embodiments may include systems and methods for generating hotel reservations. According to one embodiment of the disclosure, there is disclosed a method. The method may include generating, by at least one computing device, a hotel bid based at least in part on hotel criteria received from a client device associated with a user, where the hotel criteria comprises at least a geographical location, a star level, an arrival date, a departure date, and an asking price for a room for each night. The method may further include identifying, by the at least one computing device, one or more hotels associated with at least the geographical location and the star level, where each of the one or more hotels is associated with a hotel bid price that is the minimum amount the hotel will accept for the room for each night. The method may further include determining, by the at least one computing device, that the hotel bid price associated with each of the one or more hotels is less than or equal to the asking price for the room for each night. The method may further include transmitting, by the at least one computing device, the hotel bid directly to one or more hotel systems associated with each of the hotels. The method may further include receiving, by the at least one computing device, one or more indications from the one or more hotel systems, where each of the one or more indications comprises at least an acceptance of the hotel bid. The method may further include randomly selecting, by the at least one computing device, a target hotel system from the one or more hotel systems to win the hotel bid. The method may further include generating, by the at least one computing device, a hotel reservation on behalf of the user at the hotel associated with the target hotel system based at least in part on the arrival date, the departure date, and the asking price identified in the hotel bid.

According to another embodiment of the disclosure, there is disclosed another method for generating hotel reservations. The method may include generating, by at least one computing device, a hotel bid based at least in part on hotel criteria received from a client device associated with a user, where the hotel criteria comprises at least a geographical location, a star level, an arrival date, a departure date, and an asking price for a room for each night. The method may further include identifying, by the at least one computing device, one or more hotels associated with at least the geographical location and the star level, where each of the one or more hotels is associated with a hotel bid price that is the minimum amount the hotel will accept for the room for each night. The method may further include determining, by the at least one computing device, that the hotel bid price associated with each of the one or more hotels is greater than the asking price for the room for each night. The method may further include identifying, by the at least one computing device, a subset of the one or more hotels that receive hotel bids where the hotel bid price is above the asking price for the room for each night. The method may further include transmitting, by the at least one computing device, the hotel bid directly to one or more hotel systems associated with the subset of the one or more hotels. The method may further include receiving, by the at least one computing device, one or more counteroffers from the one or more hotel systems associated with each of the hotels in the subset, where each of the one or more counteroffers comprises at least a new asking price for the room at the hotel for each night. The method may further include selecting, by the at least one computing device, a target hotel system, where the target hotel system is associated with the new asking price that is the lowest. The method may further include generating, by the at least one computing device, a counteroffer hotel bid to present to the user, where the counteroffer hotel bid comprises at least the new asking price associated with the target hotel system. The method may further include transmitting, by the at least one computing device, the counteroffer hotel bid to the client device associated with the user via a network. The method may further include receiving, by the at least one computing device, an indication from the client device associated with the user that comprises at least an acceptance of the counteroffer hotel bid. The method may further include generating, by the at least one computing device, a hotel reservation at hotel associated with the target hotel system on behalf of the user based at least in part on the arrival date and the departure date identified in the hotel bid and the new asking price identified in the counteroffer hotel bid.

According to another embodiment of the disclosure, there is disclosed yet another method for generating hotel reservations. The method may include receiving, by at least one computing device from a client device associated with a user, hotel criteria comprising at least a geographical location, a star level, an arrival date and a departure date. The method may further include identifying, by the at least one computing device, one or more hotels associated with at least the geographical location and the star level, wherein each of the one or more hotels would like to be displayed to users. The method may further include transmitting, by the at least one computing device, to the client device, a list of the one or more hotels matching at least the geographical location and the star level. The method may further include receiving, by the at least one computing device from the client device, a selection of a target hotel from the list of the one or more hotels and an asking an asking price for a room for each night at the target hotel. The method may further include generating, by the at least one computing device, a hotel bid based at least in part on the hotel criteria and the asking price for the room for each night at the target hotel. The method may further include transmitting, by the at least one computing device, the hotel bid directly to a hotel system associated with the target hotel. The method may further include receiving, by the at least one computing device, an indication from the hotel system associated with the target hotel, wherein the indication comprises at least an acceptance of the hotel bid. The method may further include generating, by the at least one computing device, a hotel reservation at the target hotel based at least in part on the arrival date, the departure date and the asking price in the hotel bid.

According to yet another embodiment of the disclosure, there is disclosed a system for generating hotel reservations. The system may include at least one memory configured to store computer-executable instructions and at least one computing device configured to access at least one memory and execute the computer-executable instructions. The instructions may be configured to generate a hotel bid based at least in part on hotel criteria received from a client device associated with a user, where the hotel criteria comprises at least a geographical location, a star level, an arrival date, a departure date, and an asking price for a room for each night. The instructions may be further configured to identify one or more hotels associated with at least the geographical location and the star level, where each of the one or more hotels is associated with a hotel bid price that is the minimum amount the hotel will accept for the room for each night. The instructions may be further configured to determine that the hotel bid price associated with each of the one or more hotels is less than or equal to the asking price for the room for each night. The instructions may be further configured to transmit the hotel bid directly to one or more hotel systems associated with each of the one or more hotels. The instructions may be further configured to receive one or more indications from the one or more hotel systems, where each of the one or more indications comprises at least an acceptance of the hotel bid. The instructions may be further configured to randomly select a target hotel system from the one or more hotel system to win the hotel bid. The instructions may be further configured to generate a hotel reservation at the hotel associated with the target hotel system on behalf of the user based at least in part on the arrival date, the departure date, and the asking price identified in the hotel bid.

Other embodiments, systems, methods, aspects, and features of the disclosure will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. The use of the same reference numbers in different figures indicates similar or identical items.

FIG. 1 illustrates an example system for generating hotel reservations, according to an embodiment of the disclosure.

FIG. 2 is a flow diagram of an example method for generating hotel reservations, according to an embodiment of the disclosure.

FIG. 3 is a flow diagram of another example method for generating hotel reservations, according to an alternate embodiment of the disclosure.

FIG. 4 is a flow diagram of another example method for generating hotel reservations, according to an alternate embodiment of the disclosure.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

Various embodiments of the present disclosure provide for direct transmittal of hotel bids between users and hotels using a third party hotel bidding system. In certain embodiments, a hotel reservation at a hotel may be generated on behalf of a user by the third party hotel bidding system based at least in part on an asking price specified by the user. In certain embodiments, the third party hotel bidding system may receive various hotel criteria from a client device associate with a user via a network. For instance, in one embodiment, a user may interact with a website or webpage hosted by the third party hotel bidding system to input and transmit hotel criteria relating to the type of hotel they wish to book a room at, such as, for example, a geographical location of the hotel, a star level associated with the hotel, an arrival date, a departure date, an asking price the user would like to pay for a room per a night at the hotel, and the like. In one embodiment, the third party hotel bidding system may generate a hotel bid based at least in part on the hotel criteria received from the client device associated with the user. Thereafter, the third party hotel bidding system may identify one or more hotels matching at least the geographical area and star level specified by the user. The third party hotel bidding system may further determine that each of the one or more hotels is associated with a hotel bid price (i.e. the minimum amount of money the hotel would accept in exchange for a room at the hotel) that is less than or equal to the asking price in the hotel bid. The third party hotel bidding system may then transmit the hotel bid directly to one or more hotel systems associated with each of the one or more hotels via a network. Thereafter, the third party hotel bidding system may receive one or more acceptances of the hotel bid from the one or more hotel systems associated with each of the hotels via the network. In certain embodiments, the one or more hotel systems may, either automatically or manually, transmit an acceptance of the hotel bid to the third party hotel bidding system via the network. Upon receiving more than one acceptance of the hotel bid, the third party hotel bidding system may randomly select one of the hotel systems, also referred to as the target hotel system, to win the hotel bid. Thereafter, the third party hotel bidding system may generate a hotel reservation on behalf of the user at the hotel associated with the target hotel system based at least on the arrival date, the departure date and the asking price specified in the hotel bid. The third party hotel system may then transmit the hotel reservation to the client device associated with the user as well as the selected hotel system via the network.

Additionally, in certain embodiments, a hotel reservation at a hotel may be generated on behalf of a user by the third party hotel bidding system based at least in part on a new bid price received as a counteroffer from a hotel system. For instance, in certain embodiments, the third party hotel bidding system may be able to identify hotels matching the geographical area and star level specified in the hotel bid, but where all of the hotels are associated with a hotel bid price that is above the asking price specified by the user. In this example, the third party hotel bidding system may identify a subset of the one or more hotels that wish to receive hotel bids where the asking price is below the hotel bid price. The third party hotel bidding system may then transmit the hotel bid directly to the one or more hotel systems associated with each of the hotels in the subset via a network. In one embodiment, each of the hotel system may transmit a single counteroffer back to the third party hotel system via the network, where the counteroffer includes at least a new asking price that the hotel would accept in exchange for a room at the hotel. Upon receiving one or more counteroffers, the third party hotel bidding system may then select a hotel system, also referred to as a target hotel system, that is associated with lowest new asking price. The third party hotel bidding system may then generate a counteroffer hotel bid that comprises at least the new asking price associated with the target hotel system. The third party hotel bidding system may then transmit the counteroffer hotel bid to the client device associated with the user via the network. Upon receiving an acceptance of the counteroffer hotel bid from the client device associated with the user via the network, the third party hotel bidding system may generate a hotel reservation on behalf of the user at the hotel associated with the target hotel system based at least in part on the arrival and departure date specified in the hotel bid, and at the new asking price specified in the counteroffer hotel bid. The third party hotel system may then transmit the hotel reservation to the client device associated with the user and the target hotel system via the network. The technical effects associated with certain embodiments herein may include, but are not limited to, providing real-time, direct communication of hotel bids between users and hotel systems in order to facilitate competition-style bargaining as will be described in greater detail herein below. In the following discussion, a general description third party hotel bidding system and its components is provided, followed by a discussion of the operation of the same.

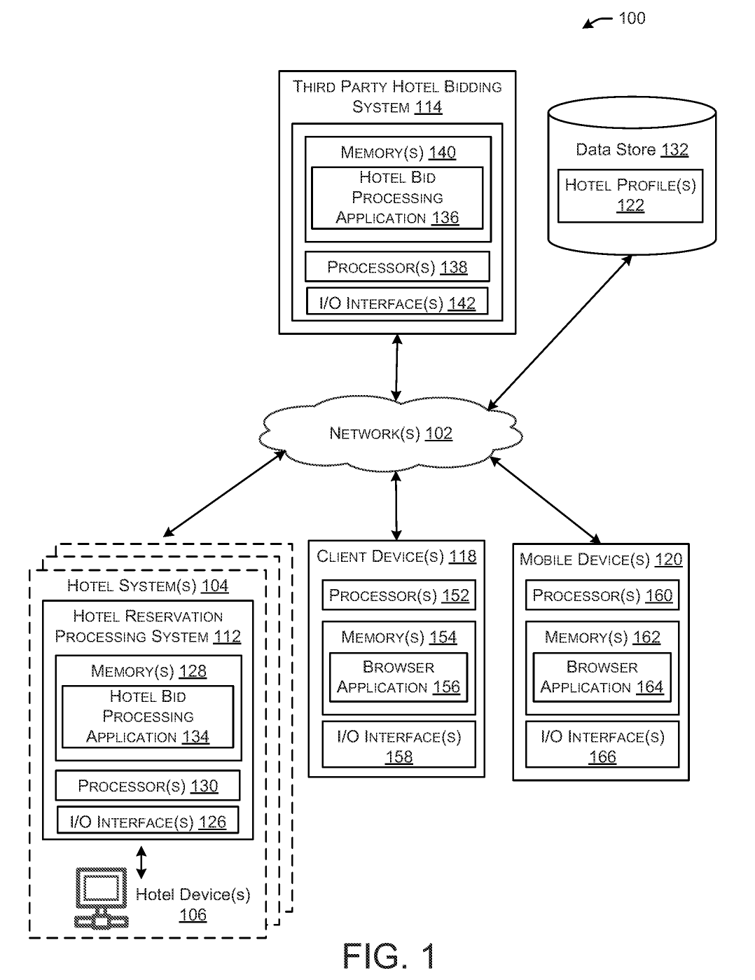

With reference to FIG. 1, shown is a networked environment 100 according to various embodiments. The networked environment 100 includes a third party hotel bidding system 114 in data communication with one or more hotel systems 104, one or more hotel devices 106, one or more client devices 118 and/or one or more mobile devices 120 by way of network 102. The network 102 includes, for example, the Internet, intranets, extranets, wide area networks (WANs), local area networks (LANs), wired networks, wireless networks, or other suitable networks, etc., or any combination of two or more such networks.

The third party hotel bidding system 114 may be operated by or on behalf of one or more trusted third parties, and is operable to communicate with any number of devices associated with one or more users, such as the client devices 118 and/or the mobile devices 120. Example client devices 118 can include, but are not limited to, personal computers, desktop computers, laptop computers, Internet appliances, netbook computers, touchpad computing devices, handheld portable computers, digital assistants, personal digital assistants, cellular phones, mobile phones, smart phones, pagers, digital tablets, and other processor-based computer devices. Example mobile devices 120 can include, but are not limited to, laptop computers, Internet appliances, netbook computers, touchpad computing devices, handheld portable computers, digital assistants, personal digital assistants, cellular phones, mobile phones, smart phones, pagers, digital tablets, and other portable processor-based computer devices.

It will be appreciated that while the disclosure may in certain instances describe only a single hotel system 104, hotel device 106, third party hotel bidding system 114, client device 118, mobile device 120; there may be multiple hotel systems, hotel devices, third party hotel bidding systems, client devices and/or mobile devices without departing from example embodiments of the disclosure.

The communications network 102 shown in FIG. 1 may include any telecommunication and/or data network, whether public, private, or a combination thereof, including a local area network, a wide area network, an intranet, an internet, the Internet, intermediate hand-held data transfer devices, a publicly switched telephone network (“PSTN”), a cellular network, and/or any combination thereof and may be wired and/or wireless. Due to network connectivity, various methodologies as described herein may be practiced in the context of distributed computing environments. It will also be appreciated that the network 102 may include a plurality of networks, each with devices such as gateways and routers for providing connectivity between or among networks. Instead of, or in addition to, a network 102, dedicated communication links may be used to connect the various devices and/or system components in accordance with an example embodiment of the disclosure.

With continued reference to FIG. 1, in certain embodiments, each of the one or more hotel systems 104 may be associated with a hotel or other establishment that provides lodging on a short-term or long-term basis for a user. The hotel system 104 may include one or more hotel devices 106, which may be used for displaying and/or accepting hotel bids received from the third party hotel bidding system 114 via network 102, and for generating and/or transmitting counteroffers to the third party hotel bidding system 114 via network 102 as will be described.

The hotel systems 104 can include or otherwise be associated with a processor and a computer-readable medium, such as RAM, ROM, and/or a removable storage device. Hotel systems 104 may operate on any operating system capable of supporting an application program including, but not limited to, Microsoft Windows®, Apple OSX™, and Linux. In one embodiment, the hotel system 104 may include computer executable program instructions stored in memory for processing transactions within the hotel system 104 and with other processors, such as processors associated with the third party hotel bidding system 114. The hotel system 104 can also include one or more I/O interface(s), such as 126, to facilitate communication via the network 102 with one or more other components of the system 100, such as hotel devices 106 and the third party hotel bidding system 114.

In certain embodiments, the hotel system 104 can include a hotel reservation processing system 112 with a respective memory 128 and processor 130. The memory 128 of the hotel reservation processing system 112 and/or those associated with the hotel devices 106 can store data and information for subsequent retrieval. For example, the memory 128 may be any computer-readable medium, such as RAM, ROM, and/or a removable storage device, coupled to the processor 130. The memory 128 may include an operating system (“OS”), such as, but not limited to, Microsoft Windows®, Apple OSX™, or Linux, and a database management system (“DBMS”) to facilitate management of data files and data stored in the memory 128 and/or stored in a data store, for example. The memories and data stores or databases can be in communication with each other and/or other databases, such as a centralized database, or other types of data storage devices. When needed, data or information stored in a memory or database may be transmitted via the network 102 to a centralized database or data store, capable of receiving data, information, or data records from more than one database or other data storage devices. In other embodiments, the data stores or databases shown can be integrated or distributed into any number of databases or data stores.

The hotel devices 106 may be any processor-based device operable to communicate over a network, such as 102. Example hotel devices 106 can include, but are not limited to, contactless transaction devices, contactless card transaction devices, PIN pads, transaction terminals, point of sale (POS) terminals, personal computers, mobile computers, handheld portable computers, digital assistants, personal digital assistants, cellular phones, mobile phones, smart phones, pagers, digital tablets, desktop computers, laptop computers, Internet appliance, or any other processor-based device. Each hotel device 106 can include a processor and a computer-readable medium, such as a random access memory (“RAM”), read only memory (“ROM”), and/or a removable storage device, coupled to the processor. The processor can execute computer-executable program instructions stored in memory. Hotel devices 106 may operate on any operating system capable of supporting a browser or browser-enabled application including, but not limited to, Microsoft Windows®, Apple OSX™, and Linux. The hotel devices 106 may include, for example, personal computers executing a browser application program such as Microsoft Corporation's Internet Explorer™, Netscape Communication Corporation's Netscape Navigator™, and Apple's Safari™, and Mozilla Firefox™. The hotel devices 106 may also include one or more input/output (“I/O”) interface(s) to facilitate communication with one or more other components of the system 100.

Furthermore, the processor 130 is operable to execute computer-executable program instructions stored in memory 128, which may include a hotel bid processing application 134. In certain embodiments, hotels systems 104 may receive hotel bids from the third party hotel bidding system 114 by incorporating hotel bid processing application 134 into their existing hotel reservation processing system 112. In this embodiment, the hotel processing application 134 can operate in conjunction with a hotel bid processing application, such as 136, associated with the third party hotel bidding system 114. The hotel bid processing application 134 can include computer-readable instructions or code operable to facilitate receiving one or more hotel bids from the third party hotel bidding system 114 via network 102, transmitting acceptances of hotel bids to the third party hotel bidding system 114 via network 102, receiving hotel reservations from the third party hotel bidding system 114 via network 102, and/or transmitting one or more counteroffers to the third party hotel bidding system 114 via network 102 as will be described. It will be appreciated that the hotel reservation processing system 112 may be implemented on a general purpose computer or may be a specialized machine in which a computer is customized to perform at least the functions of the hotel bid processing application 134 according to an example embodiment of the disclosure.

With continued reference to FIG. 1, the third party hotel bidding system 114 may include one or more processing systems, which may include server devices, mainframe computers, networked computers, a processor-based device, or any other suitable processor-based devices for electronically processing information received from one or more client devices 118 and/or mobile devices 120 associated with one or more users. The third party hotel bidding system 114 shown in FIG. 1 can include at least one processor 138, a memory 140, and one or more I/O interface(s) 142. The memory 140 may be any computer-readable medium, such as RAM, ROM, and/or a removable storage device, coupled to the processor 138. The memory 140 may include an operating system (“OS”), such as, but not limited to, Microsoft Windows®, Apple OSX™, or Linux, and a database management system (“DBMS”) to facilitate management of data files and data stored in the memory 140 and/or stored in a data store 132, for example.

The processor 138 is operable to execute computer-executable program instructions stored in memory 140, which may include a hotel bid processing application 136 that can operate in conjunction with a hotel bid processing application 134 associated with a hotel system 104. The hotel bid processing application 136 can include some or all of the instructions and code similar to the hotel bid processing application 134 of the hotel system 104. The hotel bid processing application 136 may additionally operate in conjunction with the one or more I/O interfaces 142 to facilitate communication with one or more other components of the networked environment 100, such as, with one or more hotel systems 104, one or more hotel devices 106, one or more client devices 118 and/or one or more mobile devices 120.

In certain embodiments, the hotel bid processing application 136 may be executed to facilitate the collection of hotel data from one or more hotels systems 104, which may be used to create one or more hotel profiles 122 stored in data store 132. For example, hotel data about a hotel may be provided to the hotel bid processing application 136 from a hotel system 104 via network 102. Upon receiving hotel data, the hotel bid processing application 136 may be configured to create a hotel profile 122 and store the hotel data in association with the hotel profile 122 in data store 132. In certain embodiments, the hotel bid processing application 136 may execute a search of various hotel profiles 122 stored in data store 132 via network 102 in order to identify the hotels that match hotel criteria specified by a user as will be described.

Additionally, in certain embodiments, the hotel bid processing application 136 may be executed to facilitate the collection of hotel criteria from a client device 118 or a mobile device 120 associated with a user via network 102, which may be used by the hotel bid processing application 136 to generate a hotels bid. The hotel bid processing application 136 may be configured to transmit the hotel bid to the one or more hotel systems 104 associated with one or more hotels matching some or all of the hotel criteria via network 102 as will be described.

It will be appreciated that the third party hotel bidding system 114 may be implemented on a general purpose computer or may be a specialized machine in which a computer is customized to perform at least the functions of the hotel bid processing application 136, according to an example embodiment of the disclosure. In other embodiments, the third party hotel bidding system 114 may be a distributed system, and at least some of the functionality described herein with reference to the transaction processing system may be performed in a distributed manner by one or more of the other entities and/or systems described herein.

Still referring to FIG. 1, the client device 118 may be any processor-based device operable to communicate over a network, such as 102. Example client devices can include, but are not limited to, personal computers, desktop computers, laptop computers, Internet appliances, netbook computers, touchpad computing devices, handheld portable computers, digital assistants, personal digital assistants, cellular phones, mobile phones, smart phones, pagers, digital tablets, and other processor-based computer devices. The client device 118 can include a processor, such as 152, and a computer-readable medium, such as memory 154, a random access memory (“RAM”), read only memory (“ROM”), and/or a removable storage device, coupled to the processor 152. The processor 152 can execute computer-executable program instructions stored in memory 154. Client device 118 may operate on any operating system capable of supporting a browser or browser-enabled application including, but not limited to, Microsoft Windows®, Apple OSX™, and Linux. The client device 118 may include, for example, personal computers executing a browser application program 156 such as Microsoft Corporation's Internet Explorer™, Netscape Communication Corporation's Netscape Navigator™, and Apple's Safari™, and Mozilla Firefox™. The client device 118 may also include one or more input/output (“I/O”) interface(s), such as 158, to facilitate communication with the third party hotel bidding system 114.

The mobile device 120 may be any processor-based device operable to communicate over a network, such as 102. Example mobile devices can include, but are not limited to, laptop computers, Internet appliances, netbook computers, touchpad computing devices, handheld portable computers, digital assistants, personal digital assistants, cellular phones, mobile phones, smart phones, pagers, digital tablets, and other portable processor-based computer devices. The mobile device 120 can include a processor, such as 160, and a computer-readable medium, such as memory 162, a random access memory (“RAM”), read only memory (“ROM”), and/or a removable storage device, coupled to the processor 160. The processor 160 can execute computer-executable program instructions stored in memory 162. Mobile device 120 may operate on any operating system capable of supporting a browser or browser-enabled application including, but not limited to, Microsoft Windows®, Apple OSX™, and Linux. The mobile device 120 may include, for example, personal computers executing a browser application program 164 such as Microsoft Corporation's Internet Explorer™, Netscape Communication Corporation's Netscape Navigator™, and Apple's Safari™, and Mozilla Firefox™. The mobile device 120 may also include one or more input/output (“I/O”) interface(s), such as 166, to facilitate communication with the third party hoteling bidding systems 114.

Next, a general description of the operation of the various components of the networked environment 100 in FIG. 1 is provided. To begin, in certain embodiments, a hotel may be first register with the third party hotel bidding system 114 by submitting hotel data about the hotel. Upon receiving hotel data from a hotel system 104 via network 102, the hotel bid processing application 136 may be executed to create a hotel profile 122. For example, to collect hotel data about a hotel, the hotel bid processing application 136 may be configured to generate one or more network pages that are provided to the hotel device 106 over network 102. The network page may include various text boxes or inputs that may be manipulated by a user of the hotel device 106 to input hotel data, such as where the hotel is located, the star level associated with the hotel, amenities provided by the hotel, and the like, which is then transmitted to the third party hotel bidding system 114 via network 102. Upon receiving the hotel data, the hotel bid processing system 136 may be configured to generate a hotel profile 122, which may be stored in data store 132. Additionally, in certain embodiments, in order to receive hotel bids from the third party hotel bidding system 114, a hotel may incorporate the hotel bid processing application 134 into their existing hotel reservation processing system 112 and/or hotel system 104, which can operate in conjunction with the hotel bid processing application 136 associated with the third party hotel bidding system 114 via network 102.

In certain embodiments, a hotel manager or representative can interact with various settings associated with the hotel bid processing application 134. For instance, if an automatic setting is selected, the hotel bid processing application 134 may be configured to automatically transmit an acceptance of a hotel bid received from the third party hotel bidding system 114 via network 102. Alternatively, if a manual setting is selected, the hotel bid processing application 134 may be configured to generate a network page for display on a hotel device 106 that comprises the hotel bid received from the third party hotel bidding system 114 as well as an “accept” button, which may be selected by a user of the hotel device 106 in order to accept the hotel bid. The acceptance of the hotel bid may then transmitted to the third party hotel bidding system 114 via network 102.

Similarly, a user may first register with the third party hotel bidding system 114. Accordingly, a user at a client device 118 or a mobile device 120 may transmit a request to register with the third party hotel bidding system 114 from the browser application 156 or 164 over network 102. In response to receiving the request, the hotel bid processing application 136 may be configured to serve up various network pages to the client device 118 or mobile device 120 over the network 102. The network page is generated and sent to the browser application 156 or 164 for rendering on a display device. The network page provides for various inputs components that may be manipulated by a user of the client device 118 or mobile device 120 in order to facilitate the collection of data from a user, which may be transmitted to the third party hotel bidding system 114 via network 102. Upon receiving the user data, the hotel bid processing application 136 may be configured to create a user account for the user and store the user information in association with the user account in data store 132.

For example, the user can provide user identification information, payment account information, and the like. User identification information can include, but is not limited to, a mobile phone number, a telephone number, and the like. Payment account information can include, but is not limited to, a bank account number or code, a payment account number or code, a credit card account number or code, a debit card account number or code, a stored value account number or code, or any other type of account used to exchange value between two parties. In certain other embodiments, other information may be provided to facilitate registration and/or verification of the user's identity.

In any instance, after the registration process, the hotel bid processing application 136 may be executed to facilitate the collection of hotel criteria from a user, which may be used by the hotel bid processing application 136 to generate a hotel bid. For example, using a browser application, such as 156 or 164, to communicate via the network 102, the user can interact with a website and/or webpage generated by the hotel bid processing application 136 to communicate hotel criteria, such as a geographical location of where they would like to book a room at a hotel, a star level associated with a hotel, an arrival date, a departure date, and an asking price the user would like to pay for a room each night at a hotel. In certain embodiments, the user may also provide the type of room they wish to book, such as a single bed room, a double bed room or a family room, as well as specifying room preferences and amenities, such as a smoking or non-smoking room, requesting a balcony, and the like. The hotel information may then be transmitted to the hotel bid processing application 136 via network 102. Based at least in part on the hotel criteria provided by the user, the hotel bidding processing application 136 may be configured to generate a hotel bid that comprises the hotel criteria.

Thereafter, the hotel bidding processing application 136 may be configured to identify the one or more hotels matching at least the geographical location and the star level in the hotel bid. To do so, in one embodiment, the hotel bidding processing application 136 may configured to execute a search of the various hotel profiles 122 stored in data store 132 in order to identify one or more hotels matching at least the geographical location and the star level specified by the user.

Thereafter, in certain embodiments, the hotel bidding processing application 136 may be configured to determine that a hotel bid price associated with each of the hotels is less than or equal to the asking price for the room specified in the hotel bid. To do so, in one embodiment, the hotel bidding processing application 136 may identify the one or more hotel systems 104 associated with each of the hotels matching the geographical location and start level. The hotel bid processing application 136 may then generate a request for the current hotel bid price, which may be transmitted to the one or more hotel systems 104 associated with each of the hotels via network 102. Upon receiving the request, the hotel bidding processing application 134 associated with each of the hotel systems 104 may be configured to communicate a current hotel bid price to the hotel bidding processing application 136 associated with the trusted third part hotel bidding system 114 via network 102. The hotel bid processing application 136 may then compare the current hotel bid price for each of the hotels system 104 and the asking price specified in the hotel bid to determine that the hotel bid price is less than or equal to the asking price as specified in the hotel bid.

Thereafter, the hotel bidding processing application 136 may transmit the hotel bid directly to the hotel system 104 for each of the hotels via the network 102. Upon receiving the hotel bid, in one embodiment, the hotel bidding processing application 134 may be configured to display the hotel bid on the display device of a hotel devices 106, where the hotel bid may be stored or otherwise input to the respective memory of the hotel device 106. To this end, a use of a hotel device 106 is able to see how many hotel bids they received from the third party hotel bidding system 114. In any instance, in one embodiment, the hotel bidding processing application 134 may be configured to automatically accept the hotel bid by transmitting one or more indications to third party hotel bidding system 114 via network 102. Alternatively, if a hotel manager or representative wishes to manually accept the hotel bid, then a user may interact with an input device of the hotel device 106 to generate one or more indications accepting the hotel bid, which may be transmitted to the third party hotel bidding system 114 via network 102.

Upon receiving acceptances from one or more hotel systems 104, the hotel bidding processing application 136 may be configured to randomly select one of the hotel systems 104 (the “target hotel system”) to win the hotel bid. The hotel bid processing application 136 may then identify the hotel associated with the target hotel system 104. Upon selecting the target hotel system 104 to win the hotel bid, the hotel bidding processing application 136 may generate a hotel reservation at the hotel associated with the target hotel system. To do so, in certain embodiments, the hotel bidding processing application 136 may communicate with the target hotel system 104 via network 102 to book a room at the hotel from the arrival date to the departure date identified in the hotel bid and at the asking price specified in the hotel bid. The hotel reservation may be transmitted to the client device 118 or mobile device 120 associated with the user and/or one or more hotel devices 106 associated with the target hotel system 104 that won the hotel bid. Example transmissions or communications of the hotel reservation to the user can include, but are not limited to, an electronic message, text, tweet, email, online communication, an online communication via HTTP, an online communication via an online communication protocol, a website and/or webpage posting, or other voice or electronic communication.

Other system and process embodiments in accordance with the invention can include fewer or greater numbers of components and/or process elements, and may incorporate some or all of the functionality described with respect to the system components shown in FIG. 1.

One skilled in the art may recognize the applicability of embodiments of the invention to other environments, contexts, and applications. One will appreciate that components of the system 100 and processes described with respect to FIG. 1 are provided by way of example only. Numerous other operating environments, system architectures, processes, and device configurations are possible. Accordingly, embodiments of the invention should not be construed as being limited to any particular operating environment, system architecture, process, or device configuration.

As desired, embodiments of the disclosure may include a system 100 with more or less than the components illustrated in FIG. 1. Additionally, certain components of the system 100 may be combined in various embodiments of the disclosure. The system 100 of FIG. 1 is provided by way of example only.

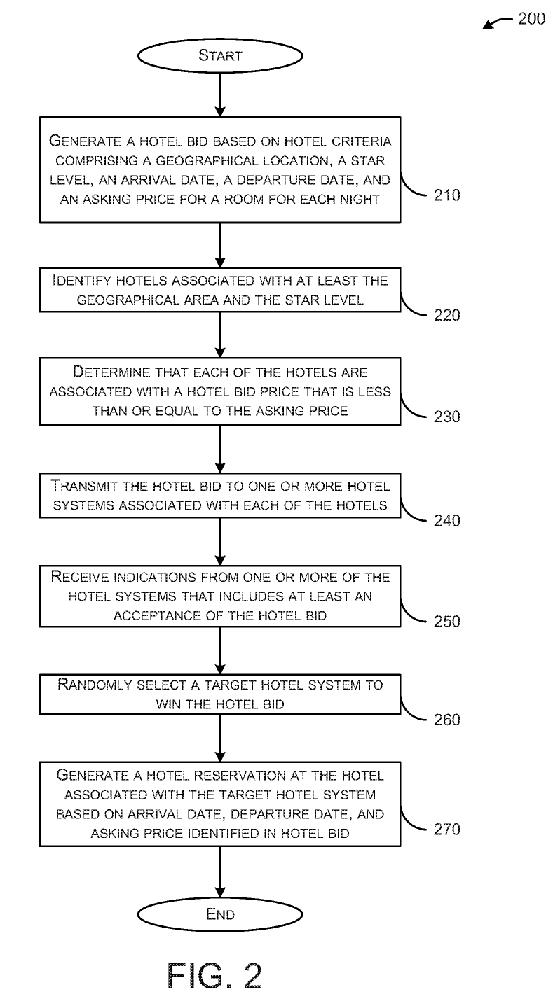

Referring now to FIG. 2, shown is a flow diagram of an example method 200 for generating a hotel reservation, according to an illustrative embodiment of the disclosure. The method 200 may be utilized in association with various systems, such as the networked environment 100 illustrated in FIG. 1.

The method 200 may begin at block 210. At block 210, a computing device, such as, 138 in FIG. 1, may generate a hotel bid based on hotel criteria that comprises a geographical location of a hotel, a star level of a hotel, an arrival date, a departure date, and an asking price for a room at the hotel for each night. As discussed above in reference to FIG. 1, the hotel criteria may be received as input from a client device, such as 118 in FIG. 1, or a mobile device, such as 120 in FIG. 1, associated with a user.

Next, at block 220, the computing device, such as 138 in FIG. 1, may identify one or more hotels associated with at least the geographical location and star level specified in the hotel bid. To do so, in certain embodiments, a hotel bid processing application, such as 136 in FIG. 1, may be executed to search one or more hotel profiles, such as 122 in FIG. 1, stored in a data store, such as 132 in FIG. 1, to identify one or more hotels matching at least the geographical location and star level in the hotel bid.

Next, at block 230, the computing device, such as 138 in FIG. 1, may determine that each of the hotels are associated with a hotel bid price that is less than or equal to the asking price for a room for each night as provided by the user and specified in the hotel bid. To do so, in one embodiment, a hotel bid processing application, such as 136 in FIG. 1, may be configured to identify the one or more hotel systems, such as 104 in FIG. 1, associated with the one or more hotels matching at least the geographical location and star level. The hotel bid processing application may then be further configured to transmit a request for the current hotel bid price to each of the hotel systems via a network, such as 102 in FIG. 1. The hotel bid processing application may then compare the hotel bid price and the asking price to determine that each of the hotels are associated with a hotel bid price that is less than or equal to the asking price for a room for each night as specified in the hotel bid.

Next, at block 240, the computing device, such as 138 in FIG. 1, may transmit the hotel bid directly to one or more hotel systems, such as 104 in FIG. 1, associated with each of the hotels matching the geographical location and star level. In certain embodiments, the hotel bid processing application, such as 136 in FIG. 1, may be configured to transmit the hotel bid directed to hotel bid processing application, such as 134 in FIG. 1, via a network, such as 102 in FIG. 1.

Next, at block 250, the computing device, such as 138 in FIG. 1, may receive one or more indications from one or more hotel systems, such as 104 in FIG. 1, that include at least an acceptance of the hotel bid. In certain embodiments, the hotel bid processing application, such as 134 in FIG. 1, associated with the hotel system, such as 104 in FIG. 1, may be configured to either automatically or manually accept hotel bids.

Next, at block 260, the computing device, such as 138 in FIG. 1, may randomly select one of the hotel systems, such as 104 in FIG. 1, to win the hotel bid. That is, when the hotel bid processing application, such as 136 in FIG. 1 receives more than one acceptance of a hotel bid, the hotel bid processing application may be configured to randomly select one of the hotel systems, also referred to as a target hotel system, to win the hotel bid.

Lastly, at block 270, the computing device, such as 138 in FIG. 1, may generate a hotel reservation at the hotel associated with the target hotel system, such as 104 in FIG. 1. In certain embodiments, the hotel bid processing application, such as 136 in FIG. 1, may be configured to book or otherwise reserve a room at the hotel associated with the target hotel system on behalf of the user. The room may be book from the arrival date to the departure date specified in the hotel bid, and the price of the room for each night is the asking price specified in the hotel bid.

The method 200 of FIG. 2 may optionally end following block 270.

The operations described and shown in the method 200 of FIG. 2 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 2 may be performed.

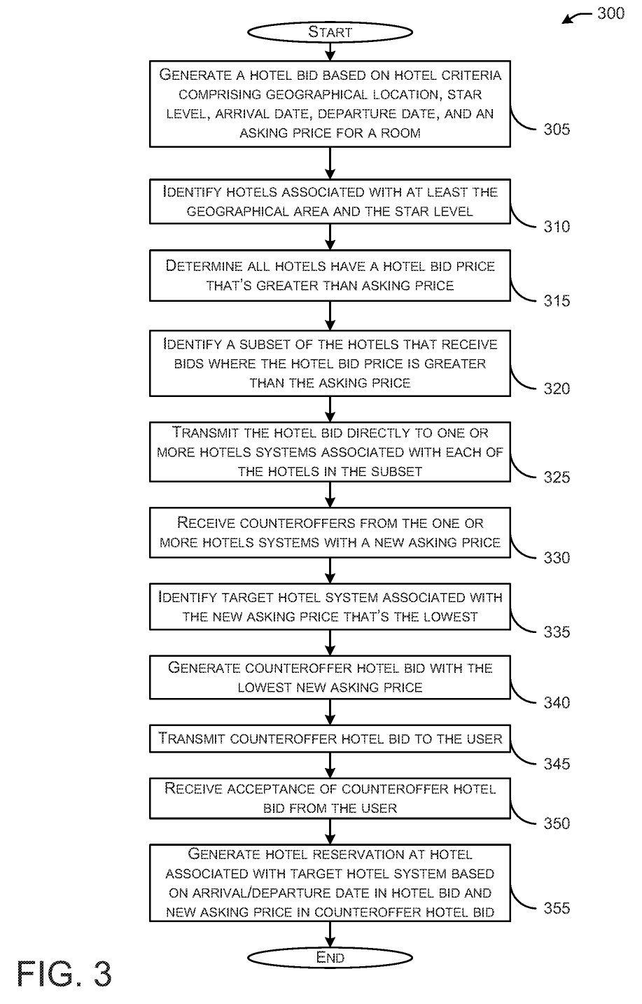

Referring now to FIG. 3, shown is a flow diagram of another example method 300 for generating a hotel reservation based on a counteroffer hotel bid, according to an illustrative embodiment of the disclosure. The method 300 may be utilized in association with various systems, such as the networked environment 100 illustrated in FIG. 1.

The method 300 may begin at block 305. At block 305, a computing device, such as, 138 in FIG. 1, may generate a hotel bid based on hotel criteria that comprises a geographical location of a hotel, a star level of a hotel, an arrival date, a departure date, and an asking price for a room at the hotel for each night. As discussed above in reference to FIG. 1, the hotel criteria may be received as input from a client device, such as 118 in FIG. 1, or a mobile device, such as 120 in FIG. 1, associated with a user.

Next, at block 310, the computing device, such as 138 in FIG. 1, may identify one or more hotels associated with at least the geographical location and star level specified in the hotel bid. To do so, in certain embodiments, a hotel bid processing application, such as 136 in FIG. 1, may be executed to search one or more hotel profiles, such as 122 in FIG. 1, stored in a data store, such as 132 in FIG. 1, via a network, such as 102 in FIG. 1, to identify one or more hotels matching at least the geographical location and star level in the hotel bid.

Next, at block 315, the computing device, such as 138 in FIG. 1, may determine that all of the hotels matching the geographical location and star level are associated with a hotel bid price that is greater to the asking price for a room for each night as specified in the hotel bid. To do so, in one embodiment, a hotel bid processing application, such as 136 in FIG. 1 may be configured to transmit a request for the current hotel bid price to each of the hotel systems, such as 104 in FIG. 1, associated with the one or more hotels that matched the geographical area/star level via a network, such as 102 in FIG. 1. Upon receiving the hotel bid price, the hotel bid processing application may then compare the hotel bid price and the asking price to determine that all of hotels are associated with a hotel bid price that is greater than the asking price in the hotel bid.

Next, at block 320, the computing device, such as 138 in FIG. 1, may identify a subset of the hotels that receive hotel bids where the hotel bid price is greater than the asking price for a room for each night as specified in the hotel bid.

Next, at block 325, the computing device, such as 138 in FIG. 1, may transmit the hotel bid directly to one or more hotel systems, such as 104 in FIG. 1, associated with each of the hotels in the subset. In certain embodiments, the hotel bid processing application, such as 136 in FIG. 1, may be configured to transmit the hotel bid directed to hotel bid processing application, such as 134 in FIG. 1, via a network, such as 102 in FIG. 1.

Next, at block 330, the computing device, such as 138 in FIG. 1, may receive one or more counteroffers from the one or more hotel systems, such as 104 in FIG. 1, associated with each of the hotels in the subset, where the counteroffer includes at least at least a new asking price for a room at the hotel per a night. In certain embodiments, the hotel system associated with each of the hotels in the subset may only submit one counteroffer in response to each hotel bid.

Next, at block 335, the computing device, such as 138 in FIG. 1, may identify the hotel system, such as 104 in FIG. 1, associated with a counteroffer having the lowest new asking price to win the hotel bid. That is, when the hotel bid processing application, such as 136 in FIG. 1 receives more than one counteroffer, the hotel bid processing application may be configured to compare all of the new asking prices and identify the hotel system (also referred to as the target hotel system) that is associated with the lowest new asking price to win the hotel bid.

Next, at block 340, the computing device, such as 138 in FIG. 1, may generate a counteroffer hotel bid to present to the user that includes at least the lowest new asking price received from the “target” hotel system, such as 104 in FIG. 1 as discussed in reference to block 335. To do so, in one embodiment, the hotel bid processing application, such as 136 in FIG. 1, may be configured to serve up one or more network pages that include the counteroffer hotel bid to the client device, such as 118 in FIG. 1, over network, such as 102 in FIG. 1.

Next, in block 345, the computing device, such as 138 in FIG. 1, may transmit the counteroffer hotel bid to the client device, such as 118 in FIG. 1, associated with the user via a network, such as 102 in FIG. 1.

Next, in block 350, the computing device, such as 138 in FIG. 1, may receive an indication from the client device, such as 118 in FIG. 1, that include at least an acceptance of the new asking price in the counteroffer hotel bid via network, such as, 102 in FIG. 1.

Lastly, at block 355, the computing device, such as 138 in FIG. 1, may generate a hotel reservation at the hotel associated with the target hotel system, such as 104 in FIG. 1. In certain embodiments, the hotel bid processing application, such as 136 in FIG. 1, may be configured to book or otherwise reserve a room at the hotel associated with the target hotel system on behalf of the user, where the room is reserved from the arrival date to the departure date specified in the hotel bid, and the cost of the room for each night is the new asking price specified in the counteroffer hotel bid. To do so, in one embodiment, the hotel bid processing application can communicate with a hotel reservation processing system, such as 112 FIG. 1, associated with the target hotel system via a network, such as network 102 in FIG. 1.

The method 300 of FIG. 3 may optionally end following block 355.

The operations described and shown in the method 300 of FIG. 3 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 3 may be performed.

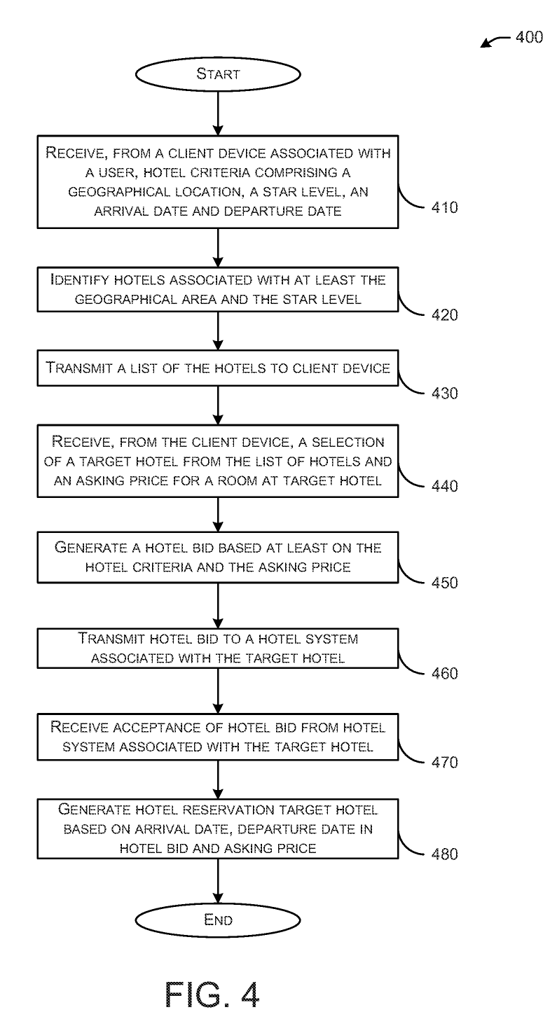

Referring now to FIG. 4, shown is a flow diagram of an example method 400 for generating a hotel reservation, according to an alternate embodiment of the disclosure. The method 400 may be utilized in association with various systems, such as the networked environment 100 illustrated in FIG. 1.

The method 400 may begin at block 410. At block 410, a computing device, such as, 138 in FIG. 1, may receive hotel criteria from a client device, such as, 118 in FIG. 1, that is associated with a user via a network, such as 102 in FIG. 1. In certain embodiments, the third party bidding system, such as 114 in FIG. 1, may serve up one or more network pages for display on the client device that includes a “bid now” button that a user at the client device can select in order to be directed to another network page having one or more input components to input hotel criteria that includes at least a geographical location, a star level, an arrival date, a departure date and/or a number of rooms. Upon inputting the hotel criteria, the user at the client device can click on or otherwise select a “direct bid” button in order to search hotels that wish to be identified by name and engage in direct bidding with the user.

Next, at block 420, the computing device, such as 138 in FIG. 1, may identify one or more hotels that are associated with at least the geographical location and star level specified in the hotel criteria and that wish to be identified by name when engaging in direct bidding with the user. To do so, in certain embodiments, a hotel bid processing application, such as 136 in FIG. 1, may be executed to search one or more hotel profiles, such as 122 in FIG. 1, stored in a data store, such as 132 in FIG. 1, to identify one or more hotels matching the geographical location and star level. Similarly, the hotel bid processing application may execute a search of the one or more hotel profiles to identify the one or more hotels that wish to be identified by name and engage in direct bidding. That is, each hotel profile may include hotel data that specifies whether the hotel wants to be identified by name when a user selects the “direct bid” button.

Next, at block 430, the computing device, such as 138 in FIG. 1, may transmit a list of the one or more hotels matching the geographical location, the star level, and that wish to be listed by name, to the client device, such as 118 in FIG. 1, associated with the user via a network, such as 102 in FIG. 1. To do so, in certain embodiments, the third party hotel bidding system, such as 114 in FIG. 1, may generate one or more network pages that may be served up for display on the client device that includes a list of hotels. For example, for each hotel in the list, the network page may include a name of the hotel, one or more images of the hotel, the location of the hotel, and a link that the user can click on to view more information about a particular hotel.

Next, at block 440, the computing device, such as 138 in FIG. 1, may receive a selection of a target hotel from the list of the one or more hotels and an asking an asking price for a room for each night from the client device, such as 118 in FIG. 1, via a network, such as, 102 in FIG. 1. As discussed in block 430, the third party bidding system may generate a network page for display on the client device that includes the list of the one or more hotels. In one embodiment, the network page may include a “bid this hotel” button next to each of the hotels the user can click on in order to select a target hotel from the list of hotels the user would like bid on. The network page may further include an input box that allows the user to input an asking price for a room for each night at the target hotel. The selection of the target hotel along with the asking price may then be transmitted from the client device to the third party bidding system via the network.

Next, at block 450, a computing device, such as, 138 in FIG. 1, may generate a hotel bid based on hotel criteria (received from the client device in block 410) and the asking price (received from the client device in block 440). Accordingly, in one embodiment, the hotel bid may include an arrival date, a departure date, and an asking price for a room at the hotel for each night.

Next, at block 460, the computing device, such as 138 in FIG. 1, may transmit the hotel bid directly to a hotel system, such as 104 in FIG. 1, associated with the target hotel. In certain embodiments, the hotel bid processing application, such as 136 in FIG. 1, may be configured to transmit the hotel bid directed to hotel bid processing application, such as 134 in FIG. 1, via a network, such as 102 in FIG. 1.

Next, at block 470, the computing device, such as 138 in FIG. 1, may receive one or more indications from the hotel system, such as 104 in FIG. 1, associated with the target hotel that includes at least an acceptance of the hotel bid. Alternatively, in one embodiment, upon receiving the hotel bid, the hotel bid processing application, such as 134 in FIG. 1, of the hotel system, such as 104 in FIG. 1, associated with the target hotel, may be able to make a counteroffer to the hotel bid. In this case, operations would continue to blocks 340, 345, 350, and 355 as discussed in reference to FIG. 3. Otherwise, if the computing device and/or the third party hotel bidding system receives an acceptance of the hotel bid from the hotel system associated with the target hotel, then operations continue to block 480.

Next, at block 480, the computing device, such as 138 in FIG. 1, may generate a hotel reservation at the target hotel. In certain embodiments, the hotel bid processing application, such as 136 in FIG. 1, may be configured to book or otherwise reserve a room at the target hotel on behalf of the user by interacting with the hotel system, such as 104 in FIG. 1, associated with the target hotel. The hotel reservation may book a room at the target hotel from the arrival date to the departure date and at the asking price specified in the hotel bid.

The method 400 of FIG. 4 may optionally end following block 480.

The operations described and shown in the method 400 of FIG. 4 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 4 may be performed.

The disclosure is described above with reference to block and flow diagrams of systems, methods, apparatus, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

The invention is described above with reference to block and flow diagrams of systems, methods, apparatus, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method for generating hotel reservations, the method comprising:
generating, by at least one computing device, a hotel bid based at least in part on hotel criteria received from a client device associated with a user, wherein the hotel bid comprises at least: a geographical location, a star level, an arrival date, a departure date, and an asking price for a room for each night;
identifying, by the at least one computing device, one or more hotels associated with at least the geographical location and the star level, wherein each of the one or more hotels is associated with a hotel bid price that is the minimum amount the hotel will accept for the room for each night;
determining, by the at least one computing device, that the hotel bid price associated with each of the one or more hotels is greater than the asking price for the room for each night;
identifying, by the at least one computing device, a subset of the one or more hotels that receive bids where the hotel bid price is above the asking price for the room for each night;
transmitting, by the at least one computing device, the hotel bid directly to one or more hotel systems associated with each of the one or more hotels in the subset;
receiving, by the at least one computing device, one or more counteroffers from the one or more hotel systems associated with each of the hotels in the subset, wherein each of the one or more counteroffers comprises a new asking price for the room for each night;
identifying, by the at least one computing device, a target hotel system from the one or more hotel systems, wherein the target hotel system is associated with the new asking price that is the lowest;
generating, by the at least one computing device, a counteroffer hotel bid to present to the user, wherein the counteroffer hotel bid comprises the new asking price associated with the target hotel system;
transmitting, by the at least one computing device, the counteroffer hotel bid to the client device associated with the user via a network;
receiving, by the at least one computing device, an indication from the client device associated with the user, wherein the indication comprises an acceptance of the counteroffer hotel bid; and
generating, by the at least one computing device, a hotel reservation at the hotel associated with the target hotel system based at least in part on the arrival date and the departure date identified in the hotel bid and the new asking price identified in the counteroffer hotel bid.
